(19) United States
(12) Patent Application Publication
(10) Pub. No.: US 2024/0096232 A1
(43) Pub. Date: Mar. 21, 2024

(54) SAFETY FRAMEWORK WITH CALIBRATION ERROR INJECTION

(71) Applicant: Zoox, Inc., Foster City, CA (US)

(72) Inventor: Derek Adams, Pasadena, CA (US)

(21) Appl. No.: 17/823,776

(22) Filed: Aug. 31, 2022

(51) Int. Cl. G09B 9/048; G05D 1/00; G05D 1/02

(52) U.S. Cl. CPC G09B 9/048; G05D 1/0088; G05D 1/0214; G05D 2201/0213

(57) ABSTRACT

Techniques for determining a safety metric associated with a vehicle controller are discussed herein. To validate safe operation of a system, a simulation may be executed including determining a relative location of a simulated object within the simulation with respect to a location of a simulated vehicle, determining, based on the relative location of the simulated object, an adjusted location of the simulated object within the simulation, controlling, by the autonomous vehicle controller and based on the relative location of the simulated object, the simulated vehicle to follow a trajectory within the simulation, and performing a collision check between the simulated vehicle and the simulated object at the adjusted location. The safety metric associated with the autonomous vehicle controller may then be determined based at least in part an outcome of the collision check.

### BACKGROUND

An autonomous vehicle can use an autonomous vehicle controller to guide the autonomous vehicle through an environment. For example, the autonomous vehicle controller can use planning methods, apparatuses, and systems to determine a drive path and guide the autonomous vehicle through the environment that contains dynamic objects (e.g., vehicles, pedestrians, animals, and the like) and static objects (e.g., buildings, signage, stalled vehicles, and the like). However, in order to ensure safety of the occupants, it's important to validate the safety of the controller.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example of generating miscalibration collision data associated with an autonomous vehicle controller based on a scenario, in accordance with examples of the disclosure.

FIG. 2 illustrates an example of a set of relative locations for which scaling factors or offsets may be determined and stored in a miscalibration lookup table, in accordance with examples of the disclosure.

FIG. 3 illustrates examples in which simulated miscalibration data such as scaling factor(s) or offset(s) may be generated for relative location of the set of relative locations, in accordance with examples of the disclosure.

FIG. 4 illustrates an example of the determination of a shift to be applied to a simulated object, in accordance with examples of the disclosure.

FIGS. 5A-5C illustrate an example driving simulation that may be conducted by the system that includes the collision checker and the miscalibration factor component, in accordance with examples of the disclosure.

FIG. 6 depicts a block diagram of an example system for implementing the techniques discussed herein.

FIG. 7 depicts an example process for determining a miscalibration lookup table that may be used in safety testing an autonomous vehicle controller, in accordance with examples of the disclosure.

FIG. 8 depicts a flow diagram of an example process for determining whether adverse events may occur due to miscalibration of one or more sensors of a simulated autonomous vehicle, in accordance with examples of the disclosure.

### DETAILED DESCRIPTION

Techniques described herein are directed to various aspects of determining performance metrics of a system despite sensor miscalibration. In at least some examples described herein, such performance metrics may be determined, for example, using simulations in conjunction with other performance metric determinations. Simulations can be used to validate software (e.g., a vehicle controller) to be executed on vehicles (e.g., autonomous vehicles or otherwise) and gather safety metrics to ensure that the software is able to safely control such vehicles in various scenarios despite sensor miscalibration. In additional or alternative examples, simulations can be used to learn about the constraints of autonomous vehicles that use the autonomous controller, such as whether a miscalibration is likely to cause an adverse event (e.g., a near-collision, a collision, or an impact). Simulations can also be useful for generating feedback for improving operations and designs of autonomous vehicles. For instance, in some examples, simulations can be useful for determining an amount of miscalibration that an autonomous vehicle controller may be capable of handling without resulting in an adverse event.

When creating a simulation environment to perform testing and validation, it is possible to specifically enumerate the environment with various and specific examples. Each instantiation of such an environment can be unique and defined.

For example, a vehicle or multiple vehicles can traverse an environment and generate log data associated with the environment. The log data can include sensor data captured by one or more sensors of the vehicle, perception data indicating objects identified by one or more systems onboard the vehicle (or produced during a post-processing phase), prediction data indicating an intent of objects (whether produced during the recording or subsequent thereto), and/or status data indicating diagnostic information, trajectory information, and other information generated by the vehicle. The vehicle can transmit the log data, via a network, to a database that stores log data and/or to a computing device that analyzes the log data.

Based on the log data, the computing device can determine a scenario(s) that can be used in simulation. In some instances, the simulation can be used to test the safety of the autonomous vehicle controller when a vehicle has miscalibrated, defective and/or a faulty sensor(s) (hereinafter, miscalibrated sensor(s)). In such an example, the computing device can be configured to inject a miscalibration (or other form of error) of one or more sensors into a simulation based on a scenario.

By way of example and without limitation, miscalibrated sensor(s) may provide sensor data that may cause the perception system and/or prediction systems of an autonomous vehicle to incorrectly determine the present and future parameters of object(s) in the simulation environment (e.g., the location, position, velocity, and/or trajectory of the object(s), etc.). For example, where one or more sensors are not properly calibrated (e.g., not properly aligned), a distance and azimuth to an object based on sensor data thereof may be incorrect.

In operation, when a computing system executes a simulation of a scenario, the computing system may conduct the operations of the perception, prediction and planning systems of the autonomous vehicle based on the input data normally. The simulation state data (e.g., the state of the perception and prediction systems of the autonomous vehicle being simulated) may be output to a safety system, referred to herein as a collision checker. In examples according to this disclosure, the collision checker may operate to determine whether adverse events would occur if one or more objects in the scenario were closer than determined by the perception and prediction systems. More particularly, the collision checker may inject a simulated miscalibration by shifting the tracks of other objects in the collision check based on a scaling factor or an offset.

In some examples, the simulated miscalibration to be applied to another object in the simulation may be determined based on the distance and/or angle of the autonomous vehicle or sensors of the autonomous vehicle to the object.

Further, the computing device may determine a simulated miscalibration to be applied to an object at a relative location (e.g., distance and angle) in the simulation based on a sensor model that indicates the positions of the sensors on the autonomous vehicle and a range of miscalibrations for sensor(s) of an autonomous vehicle.

The computing device may perform a Monte Carlo simulation for various miscalibrations to produces a probability distribution for the correct location of the simulated object based on the relative location determined by the perception and prediction systems. More particularly, in an example, the computing device may randomly determine a current miscalibration for a current iteration that is in the range of miscalibrations for the sensor. The range of miscalibrations may be predetermined based on user input, may be determined based on data collected from operational autonomous vehicles or so on. In some examples, the determination of the current miscalibration may be biased or weighted toward greater miscalibrations along any given variable. For the current miscalibration, the computing device may determine a corrected location of the simulated object based on the current random miscalibration and the relative location determined by the perception and prediction systems. In other words, the computing device may determine a location at which the simulated object would be if the sensors had the current miscalibration and the perception and prediction systems determined the simulated object was at the relative location. This process may be repeated iteratively to generate a distribution of corrected locations for the simulated object for different miscalibrations in the range of miscalibrations.

The computing device may then determine a probability threshold boundary that includes a threshold proportion of the corrected locations for the relative location. The threshold proportion may represent a safety level or margin that may be required for verification of the autonomous vehicle controller or otherwise used to ensure safe operation of the vehicle. In some examples, the computing device may then determine a closest point on the probability threshold boundary to the autonomous vehicle as an adjusted location. Additionally or alternatively, the adjusted location may be determined by shifting the relative location by the distance from the furthest point within the probability threshold boundary from the relative location. The scaling factor or offset for the relative location may be determined based on a difference between the adjusted location and the relative location.

The determination of the scaling or offset may be performed prior to executing the simulation or at run time. For example, the collision checker may utilize a miscalibration lookup table while executing the simulation to determine the scaling or offset to apply to objects in the simulation. The miscalibration lookup table may be generated by determining adjusted locations in the manner discussed above for a plurality of corresponding relative locations around the autonomous vehicle and determining respective scaling factors or respective offsets for the plurality of relative locations, for example, based on the difference between the respective adjusted locations and the corresponding relative locations.

The scaling factors or offsets may be stored in a miscalibration lookup table and may be retrieved based on the relative locations of simulated objects during the execution of the simulation. More particularly, while executing a simulation, the computing device may determine the relative location of a simulated object and retrieve the scaling factors or offsets for the relative location closest to the simulated object's relative location or determine a weighted average of the scaling factors or offsets of the nearest relative locations in the miscalibration lookup table.

Shift(s) for the simulated objects may be determined based on the scaling factor(s) or offset(s) for the simulated objects. For example, the collision checker may determine a shift as the result of multiplying a scaling factor by the distance between the autonomous vehicle or sensors of the autonomous vehicle and the object. Additionally or alternatively, the collision checker may utilize an offset as the shift. Depending on the example, the shift(s) applied to the simulated object(s) may be determined at each update of the simulation state data or may be determined on another basis (e.g., every second, five seconds, conditionally triggered, etc.).

As mentioned above, the operations of the collision checker may be performed without interfering with the simulated operation of the perception, prediction, and planning systems of the simulated autonomous vehicle. For example, based at least in part on executing the scenario, simulation data can indicate how the autonomous vehicle controller responded to (or will respond to) the scenario and determine a successful outcome or an unsuccessful outcome for the perception, prediction, and planning systems in normal operations based at least in part on the simulation data. At the same time, the collision checker may perform adverse event detection throughout the simulation.

The collision checker may output information related to whether adverse events such as collisions would have occurred during the simulation if the one or more objects in the scenario were closer than determined by the perception and prediction systems due to a miscalibration of the sensors. In some examples, because the adjusted location is the closest point to the autonomous vehicle on the probability threshold boundary for the relative location or a point shifted by the distance from the furthest point within the probability threshold boundary from the relative location, the autonomous vehicle controller may be determined to have perform successfully in the simulation for the worst miscalibration within the probability threshold boundary. Upon completing the simulation(s) without collisions, the computing device may indicate a successful validation of the autonomous vehicle. Subsequently, the autonomous vehicle controller (and/or parameters associated with the autonomous vehicle controller) may be downloaded by (or otherwise transferred to) a vehicle for further vehicle control and operation.

Techniques described herein offer various computational efficiencies. For instance, by using the techniques described herein, computing devices require fewer computational resources and a plurality of simulated scenarios can be generated faster than what is available via conventional techniques. Conventional techniques are not scalable. For instance, generating a set of unique simulated environments—as many as are needed for training, testing, and/or validating systems (e.g., one or more components of an Al stack) onboard an autonomous vehicle (e.g., prior to such autonomous vehicle(s) being deployed in corresponding new real environments)—can take an inordinate amount of time, thereby limiting the ability to train, test, and/or validate such systems (e.g., one or more components of an Al stack) onboard an autonomous vehicle prior to entering into real scenarios and/or environments. Further, by using the techniques described herein, computing devices may perform testing, training, and validating of the perception, prediction, and planning systems onboard an autonomous vehicle for normal operation without miscalibrated sensors and validating the safety of the autonomous vehicle controller to operate with miscalibrated sensors using the same execution of the simulation. Techniques described herein are unconventional in that they leverage sensor data collected from real environments and supplement that data with additional data to generate a substantially accurate simulated environment (e.g., relative to the corresponding real environment) more efficiently than what is available with conventional techniques.

Furthermore, techniques described herein are directed to improvements in safety. That is, simulated environments resulting from generation techniques described herein can be used for testing, training, and validating systems onboard an autonomous vehicle to ensure such systems can operate autonomous vehicles safely despites sensor miscalibration when deployed in real environments. That is, simulations resulting from generation techniques described herein can be used for testing, training, and validating a perception system, a planner system, and/or a prediction system of an autonomous vehicle controller controlling an autonomous vehicle with miscalibrated sensors to navigate the autonomous vehicle along a trajectory in a real environment. Thus, such training, testing, and validating enabled by techniques described herein can provide opportunities to ensure that autonomous vehicles with miscalibrated sensors can operate in real world environments safely. As such, techniques described herein improve safety and impact navigation.

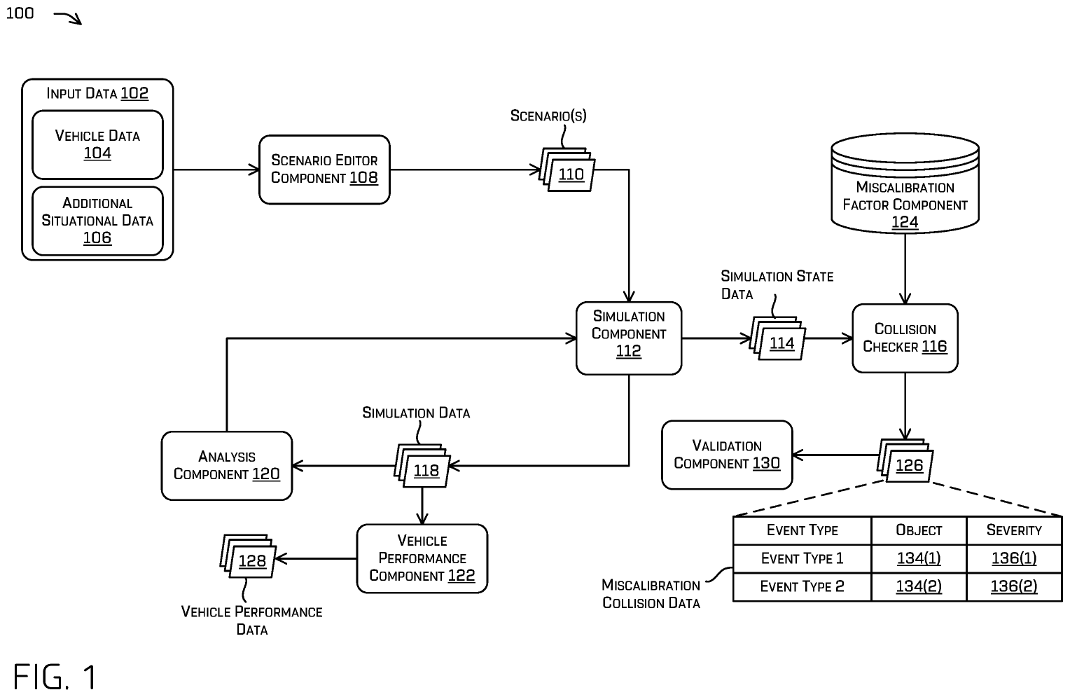

FIG. 1 illustrates an example 100 of generating miscalibration collision data associated with an autonomous vehicle controller based on a scenario. To generate a scenario, input data 102 can be used. The input data 102 can include vehicle data 104 and/or additional situational data 106. The vehicle data 104 can include log data captured by (or received by) a vehicle traveling through an environment but is not limited thereto. The log data can be used to identify scenarios for simulating an autonomous vehicle controller. For the purpose of illustration, the vehicle can be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. In such an example, since the vehicle can be configured to control all functions from start to stop, including all parking functions, it can be unoccupied. This is merely an example, and the systems and methods described herein can be incorporated into any ground-borne, airborne, or waterborne vehicle, including those ranging from vehicles that need to be manually controlled by a driver at all times, to those that are partially or fully autonomously controlled.

The vehicle can include a computing device that includes a perception engine and/or a planner and perform operations such as detecting, identifying, segmenting, classifying, and/or tracking objects from sensor data collected from the environment. For example, objects such as pedestrians, bicycles/bicyclists, motorcycles/motorcyclists, buses, streetcars, trucks, animals, and/or the like can be present in the environment.

As the vehicle traverses through the environment, the sensors can capture sensor data associated with the environment. In some examples, a vehicle can receive sensor data from one or more remote sensors. For example, some of the sensor data can be associated with objects (e.g., vehicles, cyclists, and/or pedestrians). In some instances, the sensor data can be associated with other objects including, but not limited to, buildings, road surfaces, signage, barriers, etc. Therefore, in some instances, the sensor data can be associated with dynamic objects and/or static objects. The dynamic objects can be, as described above, objects that are associated with a movement (e.g., vehicles, motorcycles, cyclists, pedestrians, animals, etc.) or capable of a movement (e.g., parked vehicles, standing pedestrians, etc.) within the environment. The static objects can be, as described above, objects that are associated with the environment such as, for example, buildings/structures, road surfaces, road markers, signage, barriers, trees, sidewalks, etc. In some instances, the vehicle computing device can determine information about objects in the environment, such as bounding boxes, classifications, segmentation information, and the like.

The vehicle computing device can use the sensor data to generate a trajectory for the vehicle. In some instances, the vehicle computing device can also determine pose data associated with a position of the vehicle. For example, the vehicle computing device can use the sensor data to determine position data, coordinate data, and/or orientation data of the vehicle in the environment. In some instances, the pose data can include x-y-z coordinates and/or can include pitch, roll, and yaw data associated with the vehicle.

The vehicle computing device can generate vehicle data 104. The vehicle data 104 can include the sensor data, perception data, planning data, vehicle status data, velocity data, intent data, sensor configuration and/or layout, and/or other data generated by the vehicle computing device. In some instances, the sensor data can include data captured by sensors such as time-of-flight sensors, location sensors (e.g., GPS, compass, etc.), inertial sensors (e.g., inertial measurement units (IMUs), accelerometers, magnetometers, gyroscopes, etc.), lidar sensors, radar sensors, sonar sensors, infrared sensors, cameras (e.g., RGB, TR, intensity, depth, etc.), microphone sensors, environmental sensors (e.g., temperature sensors, humidity sensors, light sensors, pressure sensors, etc.), ultrasonic transducers, wheel encoders, etc. The sensor data can be data captured by such sensors such as time-of-flight data, location data, lidar data, radar data, sonar data, image data, audio data, etc. Such log data may further include intermediate output by any one or more systems or subsystems of the vehicle including, but not limited to, messages indicating object detections, object tracks, predictions of future object locations, pluralities of trajectories generated in response to such detections, control signals passed to one or more systems or subsystems used to effectuate commands, and the like. In some instances, the vehicle data 104 can include time data that is associated with the other data generated by the vehicle computing device.

In some instances, input data 102 can be used to generate a scenario. The input data 102 can include vehicle data 104 and/or additional situational data 106. By way of example and without limitation, the additional situational data 106 can include data such as an incident report from a third-party source. A third-party source can include a law enforcement agency, a department of motor vehicle, and/or a safety administration that can publish and/or store reports of activities and/or incidents. For example, a report can include a type of activity (e.g., a traffic hazard such as debris on a roadway, local flooding, etc.), a location, and/or a description of the activity. By way of example and without limitation, the report can describe that a driver, while operating a vehicle, struck a fallen tree branch in a roadway while traveling at a speed of 15 meters per second. The report can be used to generate a similar scenario that can be used in simulation.

In some instances, the additional situational data 106 can include captured sensor data (e.g., image data). By way of example and without limitation, a driver of a vehicle can use a camera to capture image data while the driver operates the vehicle. In some instance, the image data can capture activity such as an incident. By way of example and without limitation, a driver can use a dashboard camera (e.g., a camera mounted on an interior dashboard of a vehicle) to capture image data while the driver operates the vehicle. As the driver operates the vehicle, an animal can run across the roadway and the driver can immediately brake to slow the vehicle. The dashboard camera can capture image data of the animal running across the roadway and the vehicle slowing down. The image data can be used to generate a scenario of an animal running across a roadway.

The input data 102, e.g., the vehicle data 104 and/or the additional situational data 106, can be used by a scenario editor component 108 to generate a scenario(s) 110. For example, the input data 102 can be input into the scenario editor component 108 which can generate a synthetic environment that represents at least a portion of the input data 102 in the synthetic environment. Examples of generating scenarios such as scenario(s) 110 and data generated by a vehicle that can be included in the vehicle data 104 can be found, for example, in U.S. patent application Ser. No. 16/392,094 titled “Scenario Editor and Simulator” and filed Apr. 23, 2019 which is incorporated by reference in its entirety.

The scenario editor component 108 can be configured to scan the input data 102 to identify one or more scenarios represented in the input data 102. By way of example and without limitation, the scenario editor component 108 can determine that a portion of the input data 102 represents a pedestrian crossing a street without a right-of-way (e.g., without a crosswalk, at an intersection without a walk indication, and the like). The scenario editor component 108 can identify this as a scenario (e.g., a jaywalking parameter) and label (and/or categorize) the scenario as, for example, a jaywalking scenario. For example, the scenario editor component 108 can use rules that define actions to generate the scenario(s) 110. By way of example and without limitation, a rule can define that a pedestrian crossing a road in a region that is not associated with a crosswalk is a jaywalker. In some instances, the scenario editor component 108 can receive label data from a user of the scenario editor component 108 to associate portions of the input data 102 with labels to generate the scenario(s) 110.

In some instances, the scenario editor component 108 can scan other portions of the input data 102 and identify similar scenarios and label the similar scenarios with the same jaywalking label. In some instances, the scenario editor component 108 can identify scenarios that do not correspond to (or is excluded from) an existing label and generate a new label for these scenarios. In some instances, the scenario editor component 108 can generate a library of scenarios and store the library of scenarios in a database within the scenario editor component 108. By way of example and without limitation, the library of scenarios can include crosswalk scenarios, merging scenarios, lane change scenarios, and the like.

In at least some examples, such scenarios 110 may be manually specified. For example, one or more users may designate certain scenarios to be tested to ensure that the vehicle is capable of safely operating when performing such scenarios, despite having never (or rarely) previously encountered the scenario.

Additional operations may be performed to customize or to tailor scenarios for use in the simulations. Examples of generating scenarios for use in simulations, such as scenario(s) 110, for example, can be found in U.S. patent application Ser. No. 16/586,838 titled “Safety Analysis Framework” and filed Sep. 27, 2019 which is incorporated by reference in its entirety.

The simulation component 112 can execute the scenario 110 as a set of simulation instructions and generate simulation data 118. In addition, the simulation component 112 may output simulation state data 114 to the collision checker 116 during or after execution of the scenario 110. For example, the simulation component 112 can instantiate a vehicle controller in the simulated scenario. In some instances, the simulation component 112 can execute multiple simulated scenarios simultaneously and/or in parallel. Additionally, the simulation component 112 can determine an outcome for the scenario 110. For example, the simulation component 112 can execute a variation of the scenario 110 for use in a simulation for testing and validation. The simulation component 112 can generate the simulation data 118 indicating how the autonomous vehicle controller performed (e.g., responded) and can compare the simulation data 118 to a predetermined outcome and/or determine if any predetermined rules/assertions were broken/triggered.

In some instances, the predetermined rules/assertions can be based on the scenario 110 (e.g., traffic rules regarding crosswalks can be enabled based on a crosswalk scenario or traffic rules regarding crossing a lane marker can be disabled for a stalled vehicle scenario). In some instances, the simulation component 112 can enable and disable rules/assertions dynamically as the simulation progresses. For example, as a simulated object approaches a school zone, rules/assertions related to school zones can be enabled and disabled as the simulated object departs from the school zone. In some instances, the rules/assertions can include comfort metrics that relate to, for example, how quickly an object can accelerate given the simulated scenario. In at least some examples, the rules may include, for example, following rules of the road, leaving a safety buffer between objects, etc.

Based at least in part on determining that the autonomous vehicle controller performed consistent with the predetermined outcome (that is, the autonomous vehicle controller did everything it was supposed to do) and/or determining that a rule was not broken or an assertion was not triggered, the simulation component 112 can determine that the autonomous vehicle controller succeeded. Based at least in part on determining that the autonomous vehicle controller performance was inconsistent with the predetermined outcome (that is, the autonomous vehicle controller did something that it wasn't supposed to do) and/or determining that a rule was broken or than an assertion was triggered, the simulation component 112 can determine that the autonomous vehicle controller failed. Accordingly, based at least in part on executing the scenario 110, simulation data 118 can indicate how the autonomous vehicle controller responds to each variation of the scenario 110, as described above and determine a successful outcome or an unsuccessful outcome based at least in part on the simulation data 118.

An analysis component 120 can be configured to determine degrees of a success or a failure. By way of example and without limitation, a rule can indicate that a vehicle controlled by an autonomous vehicle controller must stop within a threshold distance of an object. The simulation data 118 can indicate that in a first variation of the scenario 110, the simulated vehicle stopped in excess of 5 meters from the threshold distance. In a second variation of the scenario 110, the simulation data 118 can indicate that the simulated vehicle stopped in excess of 10 meters from the threshold distance. The analysis component 120 can indicate that the simulated vehicle performed more successfully in the second variation compared to the simulated vehicle in the first variation. For example, the analysis component 120 can determine an ordered list (e.g., ordered according to a relative success scale) that includes simulated vehicles and the associated variations of the scenario 110. Such variations may also be used to determine limitations of the various components of the system being simulated.

The analysis component 120 can, based on the simulation data 118, determine additional variations of the scenario 110. For example, the simulation data 118 output by the simulation component 112 can indicate variations of the scenario 110 associated with a success or a failure (which may be represented as a continuous likelihood). The analysis component 120 can determine additional variations based on the variations associated with a failure. By way of example and without limitation, a variation of the scenario 110 associated with a failure can represent a vehicle traveling on a driving surface at a speed of 15 meters per second and an animal crossing the driving surface at a distance of 20 meters in front of the vehicle. The analysis component 120 can determine additional variations of the scenario to determine additional simulation data 118 for analysis. By way of example and without limitation, the analysis component 120 can determine additional variations that include the vehicle traveling at 10 meters per second, 12.5 meters per second, 17.5 meters per second, 20 meters per second, etc. Additionally, the analysis component 120 can determine additional variations that include the animal crossing the driving surface at a distance of 15 meters, 17.5 meters, 22.5 meters, and 25 meters, etc. The additional variations can be input into the simulation component 112 to generate additional simulation data. Such additional variations may be determined based on, for example, perturbations to the parameters for the scenario being run in simulation. Examples of generating additional variations in scenarios for use in simulations can be found in U.S. patent application Ser. No. 16/586,838 titled “Safety Analysis Framework” and filed Sep. 27, 2019 which is incorporated by reference in its entirety.

The vehicle performance component 122 can, based on the simulation data 118 (and/or the additional simulation data based on the additional variations from the analysis component 120) and the types of failures, determine the vehicle performance data 128. In some instances, the vehicle performance data 128 can indicate how a vehicle performs in an environment. By way of example and without limitation, the vehicle performance data 128 can indicate that a vehicle traveling at a speed of 15 meters per second has a stopping distance of 15 meters. In some instances, the vehicle performance data can indicate safety metrics. By way of example and without limitation, the vehicle performance data 128 can indicate an event (e.g., a failure) and a cause of the event. In at least some examples, such indication may be binary (failure or not), coarse (levels of failure, e.g., “critical”, “non-critical”, and “pass), or continuous (e.g., representing a probability of failure), though any other indication is contemplated.

As discussed above, the simulation component 112 may output simulation state data 114 to the collision checker 116 during or after execution of the scenario 110.

The simulation state data 114 may include various data regarding the state of the simulation and the simulated vehicle controlled by the autonomous vehicle controller such as perception data, planning data, vehicle status data, velocity data, intent data, sensor configuration and/or layout, and/or other data generated by the simulated autonomous vehicle controller. In some examples, the simulation state data 114 may include internal state data of the autonomous vehicle controller of systems regarding object detections, object tracks, predictions of future object locations, pluralities of trajectories generated in response to such detections and so on.

The collision checker 116 may operate to determine whether adverse events would have occurred in operations of the simulation if one or more sensors of the autonomous vehicle were miscalibrated, resulting in object(s) in the scenario being closer than determined by the perception and prediction systems. In some examples, the collision checker 116 may inject a simulated miscalibration into the collision checking by shifting the tracks of other objects in the simulation based on a scaling factor or an offset.

The collision checker 116 may obtain simulated miscalibration(s) to be applied to objects in the simulation from the miscalibration factor component 124. As discussed above, depending on the example, the miscalibration factor component 124 may generate the scaling factors or offsets of the simulated miscalibration provided to the collision checker 116 prior to execution of the simulation or at run time (e.g., in response to the request for the collision checker 116).

In some examples, the miscalibration factor component 124 may determine the simulated miscalibration to be applied to an object in the simulation based on the distance and/or angle of the autonomous vehicle or sensors of the autonomous vehicle to the object and/or sensor configuration data that indicates the positions of the sensor(s) on the autonomous vehicle and a range of miscalibrations for the sensor(s). For example, the range of miscalibrations may include a range of alignment errors for a projective sensor of the autonomous vehicle. Other example miscalibrations (e.g., intrinsic or extrinsic) would be apparent to one of ordinary skill in the art in view of this disclosure.

In examples in which the simulated miscalibration is determined in advance, the miscalibration factor component 124 may utilize a miscalibration lookup table to determine the scaling or offset to apply to objects in the simulation. More particularly, the miscalibration factor component 124 may generate the miscalibration lookup table by determining scaling factors or offsets for a plurality of corresponding relative locations around the autonomous vehicle in the manner discussed below with regard to determining miscalibrations at runtime.

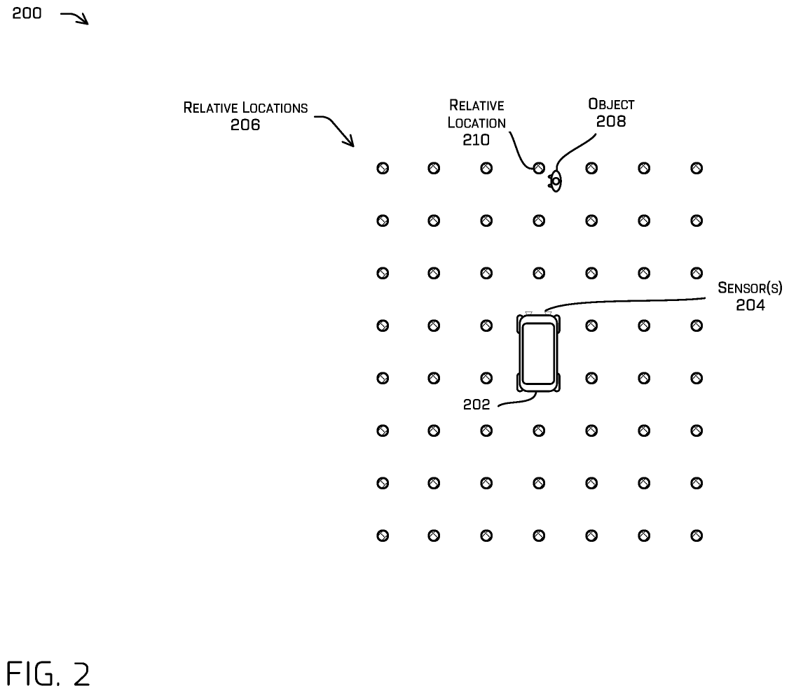

FIG. 2 illustrates an example 200 of a set of relative locations for which scaling factors or offsets may be determined and stored in a miscalibration lookup table. More particularly, example 200 includes an autonomous vehicle 202 with sensor(s) 204. The miscalibration factor component 124 may determine simulated miscalibration(s) for each of the relative locations 206 and store the simulated miscalibration(s) in a miscalibration lookup table for use during collision checking operations by the collision checker 116.

While the relative locations 206 are shown as a grid pattern, this is merely an example. In other examples, the relative locations 206 may be positioned using polar coordinates (e.g., arranged in a series of rings, with increasing diameter and with a number of relative locations per ring increasing with the circumference of the ring). In some examples, the grid may be uniform or non-uniform (e.g., a density of grid points may be based on relative locations (e.g., higher density in front of the vehicle, or higher density nearer to or farther from the vehicle), and the like).

The scaling factors or offsets may be stored in a miscalibration lookup table and may be retrieved based on the relative locations of simulated objects during the execution of the simulation. For example, when a request for simulated miscalibration data is received from the collision checker 116, the miscalibration factor component 124 may determine the relative location of the simulated object 208 and retrieve the scaling factor(s) or offset(s) for the table's relative location that is closest to the simulated object's relative location (e.g., shown here as relative location 210). Additionally or alternatively, the miscalibration factor component 124 may determine and provide a weighted average of the nearest relative locations in the miscalibration lookup table.

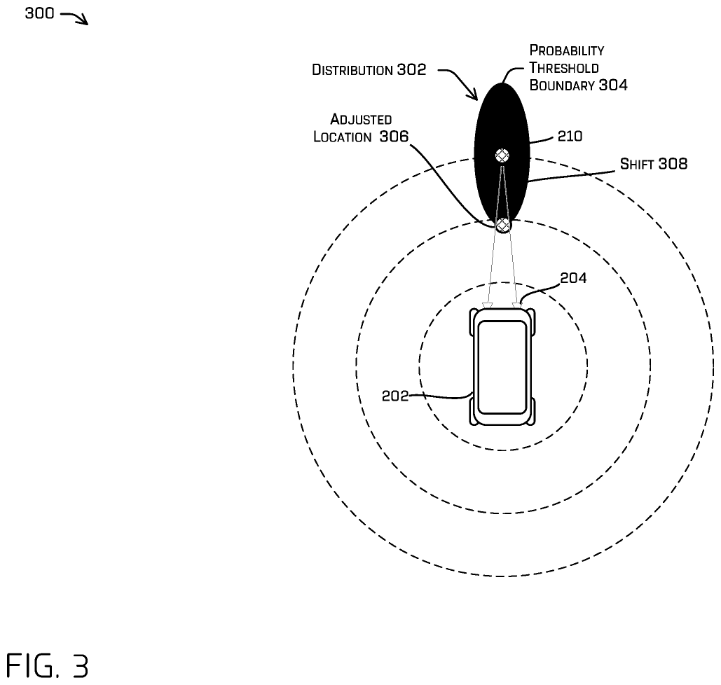

In examples in which the simulated miscalibration data is determined at run time (e.g., in response to the request for the collision checker 116), the miscalibration factor component 124 may generate the simulated miscalibration data (e.g., scaling factors or offsets) based directly on the relative locations of the simulated object(s) around the autonomous vehicle. More particularly, in an example in which the scaling factor or offset of the simulated miscalibration for the simulated object 208 is determined at run time, the operations discussed below may be performed for the relative location of the simulated object 208, instead of relative location 210, as discussed with regard to FIG. 3 below.

To generate simulated miscalibration data such as scaling factor(s) or offset(s) for a particular relative location, the miscalibration factor component 124 may perform a Monte Carlo simulation for various (e.g., random) miscalibrations to produce a probability distribution for the adjusted location of the simulated object based on the relative location determined by the perception and prediction systems.

FIG. 3 illustrate examples 300 in which simulated miscalibration data such as scaling factor(s) or offset(s) may be generated for relative location 210 of the set of relative locations 206.

More particularly, for a plurality of iterations, the miscalibration factor component 124 may randomly determine a current miscalibration for a current iteration that is in the range of miscalibrations for the sensor(s) 204. For the current miscalibration, the miscalibration factor component 124 may determine a corrected location for the relative location 210 based on the current random miscalibration and the relative location 210. In other words, the miscalibration factor component 124 may determine a location at which a simulated object would actually be if the sensors had the current miscalibration and the perception and prediction systems determined the simulated object was at the relative location 210. In the case of generating a simulated miscalibration for the simulated object 208 at runtime, the relative location of the simulated object 208 determined by the perception and prediction systems may be used in place of the relative location 210. This process may be repeated for a plurality of iterations to generate a distribution 302 of corrected locations for the relative location 210 (or 208) for different miscalibrations in the range of miscalibrations.

The miscalibration factor component 124 may then determine a probability threshold boundary 304 which includes a threshold proportion of the corrected locations for the relative location 210. The threshold proportion may represent a safety level or margin that may be required for verification of the autonomous vehicle controller (e.g., 90%, 99%, 99.9%, etc.). For example, the threshold proportion of corrected locations within the probability threshold boundary 304 may represent a level of miscalibrations within the range of miscalibrations, or combinations thereof, which the autonomous vehicle controller is required to be able to handle safely in order to be verified and/or deployed.

In some examples, the miscalibration factor component 124 may then determine a closest point on the probability threshold boundary 304 to the autonomous vehicle as an adjusted location 306. A shift 308 may be determined as the difference between the relative location 210 and the adjusted location 306. In other examples, the miscalibration factor component 124 may determine the shift 308 as a difference between the relative location 210 and a point on the probability threshold boundary 304 which is furthest from the relative location 210. The miscalibration factor component 124 may then determine the adjusted location 306 to be a point which is the distance of the shift 308 toward the autonomous vehicle from the relative location 210. In such a case, the adjusted location 306 may be closer to the autonomous vehicle than the probability threshold boundary 304.

The scaling factor or offset for the relative location 210 may then be determined based on the shift 308 and/or a difference between the location of the autonomous vehicle 202 and the relative location 210. In a particular example, the scaling factor may be the ratio of the shift 308 to the difference between the location of the autonomous vehicle 202 and the relative location 210. Alternatively or additionally, the offset may be determined to be the distance of shift 308.

The collision checker 116 may receive the scaling factor(s) or offset(s) from the miscalibration factor component 124 and determine shift(s) for the simulated objects in the simulation based thereon. In some examples, a shift may then be applied to the track of one or more simulated objects.

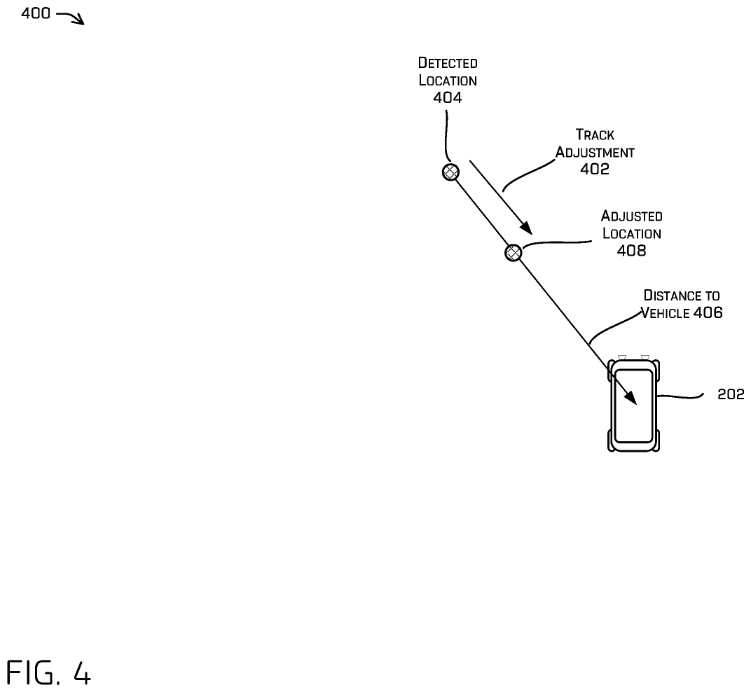

FIG. 4 illustrates an example of the determination of a shift to be applied to a simulated object. More particularly, in FIG. 4, the collision checker 116 may determine a track adjustment 402 as a shift for a simulated object at a detected location 404. The track adjustment 402 may be applied to the detected location 404 to determine the adjusted location 408.

In operation, the collision checker 116 may perform a lookup to the miscalibration lookup table of the miscalibration factor component 124 based on a distance between the detected location 404 and the vehicle 202 and an angle from the autonomous vehicle to the detected location 404. In response, the miscalibration factor component 124 may return a scaling factor. The collision checker 116 may then determine the track adjustment 402 as a product of the scaling factor and a distance 406 to the vehicle 202 from the detected location 404. The track adjustment 402 may be applied to the detected location 404 or the current position of the simulated object along the track to determine the adjusted location 408. While FIG. 4 is illustrated using a frame of reference centered on the vehicle 202, examples are not so limited and other frames of reference may be used to provide similar shift(s) 308 or track adjustments 402.

Depending on the example, shift(s) 308 or track adjustments 402 may be updated and applied to the simulated objects at each update of the simulation state data or may be applied to the track of the simulated objects until on another basis (e.g., every second, five seconds, conditionally triggered, etc.).

As mention above, the operations of the collision checker 116 may be performed without interfering with the simulation of the perception, prediction, and planning systems by the simulation component 112. For example, the simulation component 112 may perform the simulation and output the simulation data 118 to the analysis component 120 and vehicle performance component 122. At the same time, the simulation component 112 may provide the simulation state data 114 to the collision checker 116. The analysis component 120 and vehicle performance component 122 can determine how the autonomous vehicle controller responded to (or will respond to) the scenario and determine a successful outcome or an unsuccessful outcome for the perception, prediction, and planning systems in normal operations based at least in part on the simulation data 118. At the same time, the collision checker 116 may perform adverse event detection throughout the simulation based on the simulation state data 114.

The collision checker 116 may output miscalibration collision data 126 related to whether adverse events such as collisions would have occurred during the simulation if a miscalibration of the sensor(s) were present in the simulation.

Similar to the vehicle performance data 128, the miscalibration collision data 126 can indicate safety metrics. By way of example and without limitation, the miscalibration collision data 126 can indicate an adverse event (e.g., a collision) and a cause of the event. In at least some examples, such indication may be binary (collision or not), coarse (levels of failure, e.g., “high speed”, “minor”, “near miss,” and “pass”), or continuous (e.g., representing a probability of collision), though any other indication is contemplated.

For example, for an event type 1, the miscalibration collision data 126 may indicate an object 134(1) and a severity 136(1) and similarly indicate for an event type 2, an object 134(2) and a severity 136(2). In some instances, the event type may refer to the type of event (e.g., event type 1 may indicate a collision and event type 2 may indicate a near miss). The object 134 may indicate an object within the simulation which was involved in a potential collision or other event with the autonomous vehicle. The severity 136 may indicate how severe the collision or event would have been (e.g., “high speed,” “glancing,” “low speed,” etc.).

In operation, the validation component 130 may operate to determine whether the autonomous vehicle controller has been successfully validated. For example, the validation component 130 may receive the miscalibration collision data 126 from the collision checker 116. The validation component 130 may evaluate the miscalibration collision data 126 to determine a validation status of the autonomous vehicle controller. In some examples, because the adjusted location may be the closest point to the autonomous vehicle on the probability threshold boundary for the relative location or shifted by the distance from the furthest point within the probability threshold boundary from the relative location, the autonomous vehicle controller may be determined to have perform successfully in the simulation for the worst miscalibration within the probability threshold boundary for each simulated object. Upon completing the simulation(s) without collision or within other requirements (e.g., no collisions, no near misses, no severe impacts, etc.), the validation component 130 may indicate a successful validation of the autonomous vehicle controller which can subsequently be downloaded by (or otherwise transferred to) a vehicle for further vehicle control and operation.

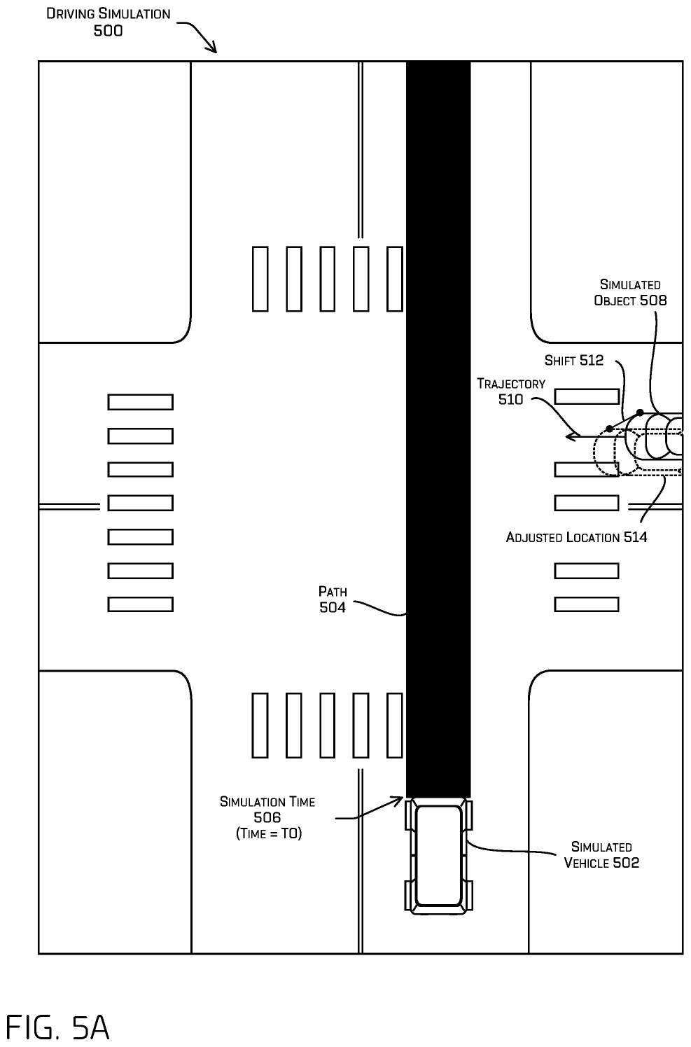

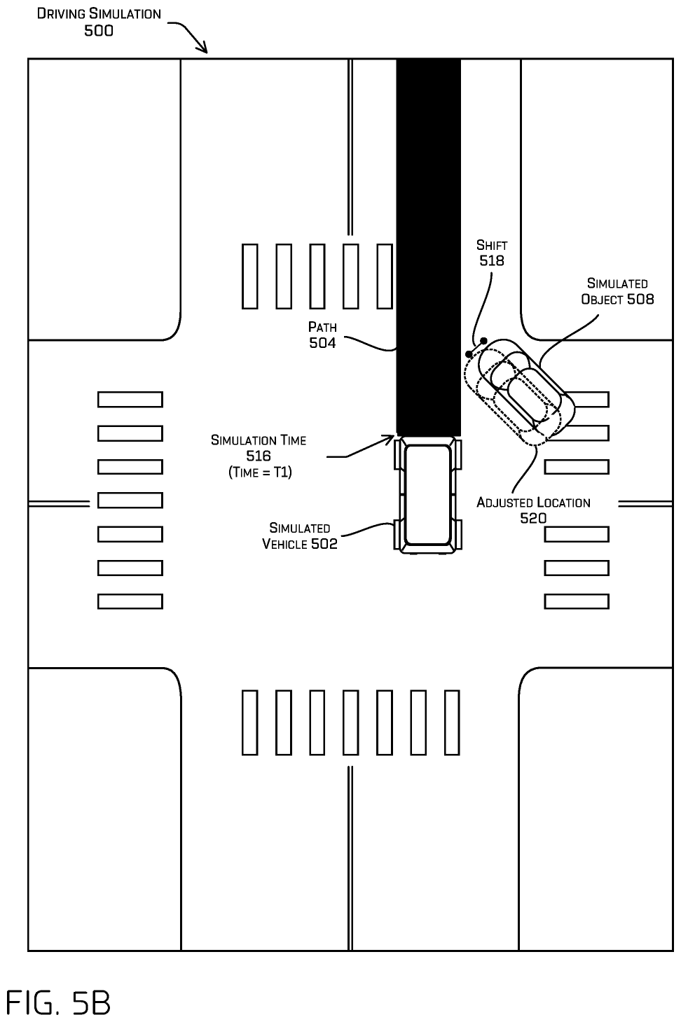

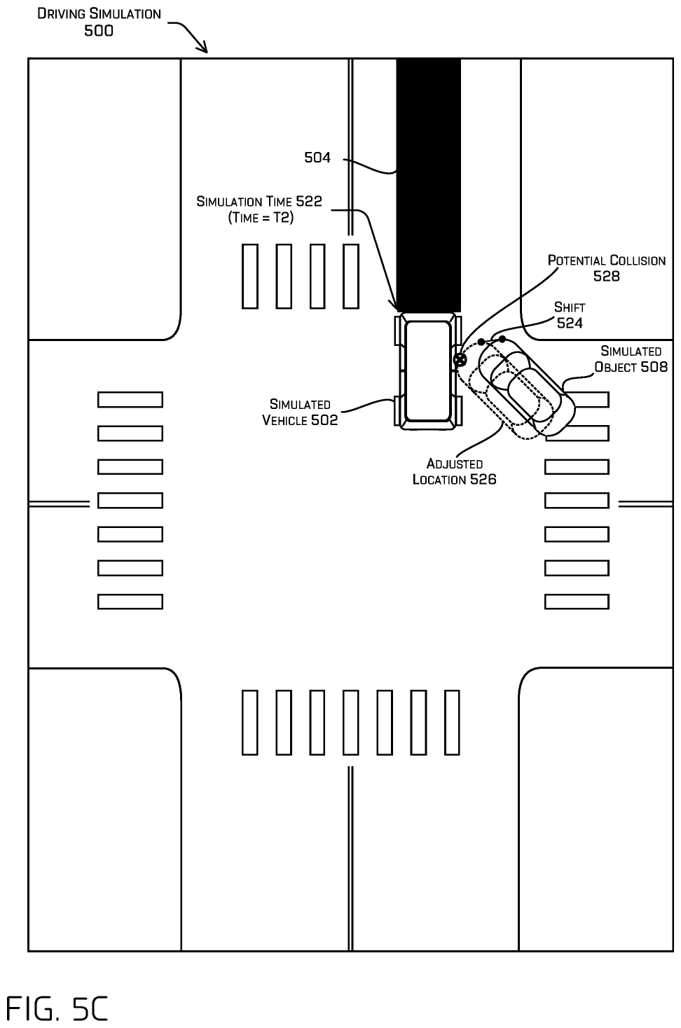

FIGS. 5A-5C illustrate an example driving simulation 500 that may be conducted by the system 100 that includes the collision checker 116 and the miscalibration factor component 124.

As shown in FIG. 5A, a simulated vehicle 502 is traveling along a path 504 at a simulation time 506 (time=TO) while a simulated object 508 is traveling along a trajectory 510 that may intersect the path 504 of the simulated vehicle 502.

As discussed above, the collision checker 116 may determine a distance between the detected location of the simulated object 508 and the simulated vehicle 502 and an angle from the simulated vehicle 502 to the detected location of the simulated object 508. The collision checker 116 may perform a lookup to the miscalibration factor component 124 based on the determined distance and angle. In response, the collision checker 116 may receive a scaling factor or offset. The collision checker 116 may determine a shift 512 based on the scaling factor or offset, the detected location of the simulated object 508 and/or the determined distance. The collision checker 116 may then determine the adjusted location 514 based on the shift 512 and the detected location of the simulated object 508.

As shown in FIG. 5B, the simulated vehicle 502 has continued traveling along the path 504 to a simulation time 516 (time=T1) while the simulated object 508 has turned and is traveling along a trajectory that may intersect the path 504 of the simulated vehicle 502.

As discussed above, the collision checker 116 may determine an updated distance between the detected location of the simulated object 508 and the simulated vehicle 502 and an updated angle from the simulated vehicle 502 to the detected location of the simulated object 508. The collision checker 116 may perform a lookup to the miscalibration factor component 124 based on the updated distance and updated angle. In response, the collision checker 116 may receive an updated scaling factor or offset. The collision checker 116 may determine a shift 518 based on the scaling factor or offset, the detected location of the simulated object 508 and/or the updated distance. The collision checker 116 may then determine an adjusted location 520 based on the shift 518 and the detected location of the simulated object 508.

As shown in FIG. 5C, the simulated vehicle 502 has continued traveling along the path 504 to a simulation time 522 (time=T2) while the simulated object 508 has continued its turn and has traveled to a location nearly intersecting the path 504 of the simulated vehicle 502.

The collision checker 116 may determine another updated distance between the detected location of the simulated object 508 and the simulated vehicle 502 and another updated angle from the simulated vehicle 502 to the detected location of the simulated object 508. The collision checker 116 may perform a lookup to the miscalibration factor component 124 based on the new updated distance and new updated angle. In response, the collision checker 116 may receive another updated scaling factor or offset. The collision checker 116 may determine a shift 524 based on the scaling factor or offset, the detected location of the simulated object 508 and/or the new updated distance. The collision checker 116 may then determine an adjusted location 526 based on the shift 524 and the detected location of the simulated object 508.

However, at simulation time 522 (time=T2), the adjusted location 526 of the simulated object 508 intersects the location of the simulated vehicle 502. As such, the collision checker 116 may determine a potential collision 528 may have occurred during the simulation if the sensors of the simulated vehicle 502 were miscalibrated (e.g., miscalibrated in the manner that resulted in the corrected location upon which the scaling factor or offset was based).

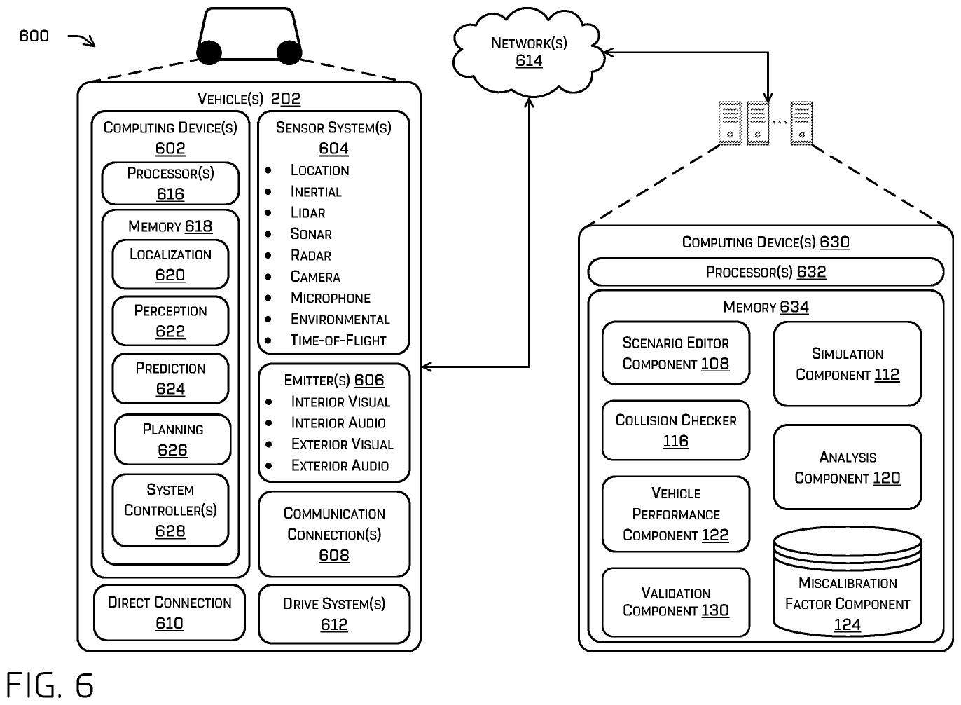

FIG. 6 depicts a block diagram of an example system 600 for implementing the techniques discussed herein. In at least one example, the system 600 can include a vehicle(s) 202. In the illustrated example 600, the vehicle(s) 202 is an autonomous vehicle; however, the vehicle(s) 202 can be any other type of vehicle (e.g., a driver-controlled vehicle that may provide an indication of whether it is safe to perform various maneuvers).

The vehicle(s) 202 can include a computing device(s) 602, one or more sensor system(s) 604, one or more emitter(s) 606, one or more communication connection(s) 608 (also referred to as communication devices and/or modems), at least one direct connection 610 (e.g., for physically coupling with the vehicle(s) 202 to exchange data and/or to provide power), and one or more drive system(s) 612. The one or more sensor system(s) 604 can be configured to capture sensor data associated with an environment.

The sensor system(s) 604 can include time-of-flight sensors, location sensors (e.g., GPS, compass, etc.), inertial sensors (e.g., inertial measurement units (IUs), accelerometers, magnetometers, gyroscopes, etc.), lidar sensors, radar sensors, sonar sensors, infrared sensors, cameras (e.g., RGB, IR, intensity, depth, etc.), microphone sensors, environmental sensors (e.g., temperature sensors, humidity sensors, light sensors, pressure sensors, etc.), ultrasonic transducers, wheel encoders, etc. The sensor system(s) 604 can include multiple instances of each of these or other types of sensors. For instance, the time-of-flight sensors can include individual time-of-flight sensors located at the corners, front, back, sides, and/or top of the vehicle(s) 202. As another example, the camera sensors can include multiple cameras disposed at various locations about the exterior and/or interior of the vehicle(s) 202. The sensor system(s) 604 can provide input to the computing device(s) 602. In some examples, the sensor system(s) 604 can receive sensor data from one or more remote sensors or other vehicles.

The vehicle(s) 202 can also include one or more emitter(s) 606 for emitting light and/or sound. The one or more emitter(s) 606 in this example include interior audio and visual emitters to communicate with passengers of the vehicle(s) 202. By way of example and not limitation, interior emitters can include speakers, lights, signs, display screens, touch screens, haptic emitters (e.g., vibration and/or force feedback), mechanical actuators (e.g., seatbelt tensioners, seat positioners, headrest positioners, etc.), and the like. The one or more emitter(s) 606 in this example also include exterior emitters. By way of example and not limitation, the exterior emitters in this example include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which may comprise acoustic beam steering technology.

The vehicle(s) 202 can also include one or more communication connection(s) 608 that enable communication between the vehicle(s) 202 and one or more other local or remote computing device(s) (e.g., a remote teleoperations computing device) or remote services. For instance, the communication connection(s) 608 can facilitate communication with other local computing device(s) on the vehicle(s) 202 and/or the drive system(s) 612. Also, the communication connection(s) 608 can allow the vehicle(s) 202 to communicate with other nearby computing device(s) (e.g., other nearby vehicles, traffic signals, etc.).

The communications connection(s) 608 can include physical and/or logical interfaces for connecting the computing device(s) 602 to another computing device or one or more external network(s) 614 (e.g., the Internet). For example, the communications connection(s) 608 can enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s). In at least some examples, the communication connection(s) 608 may comprise the one or more modems as described in detail above.

In at least one example, the vehicle(s) 202 can include one or more drive system(s) 612. In some examples, the vehicle(s) 202 can have a single drive system 612. In at least one example, if the vehicle(s) 202 has multiple drive systems 612, individual drive systems 612 can be positioned on opposite ends of the vehicle(s) 202 (e.g., the front and the rear, etc.). In at least one example, the drive system(s) 612 can include one or more sensor system(s) 604 to detect conditions of the drive system(s) 612 and/or the surroundings of the vehicle(s) 202. By way of example and not limitation, the sensor system(s) 604 can include one or more wheel encoders (e.g., rotary encoders) to sense rotation of the wheels of the drive systems, inertial sensors (e.g., inertial measurement units, accelerometers, gyroscopes, magnetometers, etc.) to measure orientation and acceleration of the drive system, cameras or other image sensors, ultrasonic sensors to acoustically detect objects in the surroundings of the drive system, lidar sensors, radar sensors, etc. Some sensors, such as the wheel encoders can be unique to the drive system(s) 612. In some cases, the sensor system(s) 604 on the drive system(s) 612 can overlap or supplement corresponding systems of the vehicle(s) 202 (e.g., sensor system(s) 604).

The drive system(s) 612 can include many of the vehicle systems, including a high voltage battery, a motor to propel the vehicle, an inverter to convert direct current from the battery into alternating current for use by other vehicle systems, a steering system including a steering motor and steering rack (which can be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive system(s) 612 can include a drive system controller which can receive and preprocess data from the sensor system(s) 604 and to control operation of the various vehicle systems. In some examples, the drive system controller can include one or more processor(s) and memory communicatively coupled with the one or more processor(s). The memory can store one or more modules to perform various functionalities of the drive system(s) 612. Furthermore, the drive system(s) 612 also include one or more communication connection(s) that enable communication by the respective drive system with one or more other local or remote computing device(s).

The computing device(s) 602 can include one or more processor(s) 616 and memory 618 communicatively coupled with the one or more processor(s) 616. In the illustrated example, the memory 618 of the computing device(s) 602 stores a localization component 620, a perception component 622, a prediction component 624, a planning component 626, and one or more system controller(s) 628. Though depicted as residing in the memory 618 for illustrative purposes, it is contemplated that the localization component 620, the perception component 622, the prediction component 624, the planning component 626, and the one or more system controller(s) 628 can additionally, or alternatively, be accessible to the computing device(s) 602 (e.g., stored in a different component of vehicle(s) 202 and/or be accessible to the vehicle(s) 202 (e.g., stored remotely).

In memory 618 of the computing device(s) 602, the localization component 620 can include functionality to receive data from the sensor system(s) 604 to determine a position of the vehicle(s) 202. For example, the localization component 620 can include and/or request/receive a three-dimensional map of an environment and can continuously determine a location of the autonomous vehicle within the map. In some instances, the localization component 620 can use SLAM (simultaneous localization and mapping) or CLAMS (calibration, localization and mapping, simultaneously) to receive time-of-flight data, image data, lidar data, radar data, sonar data, IMU data, GPS data, wheel encoder data, or any combination thereof, and the like to accurately determine a location of the autonomous vehicle. In some instances, the localization component 620 can provide data to various components of the vehicle(s) 202 to determine an initial position of an autonomous vehicle for generating a trajectory, as discussed herein.

The perception component 622 can include functionality to perform object detection, segmentation, and/or classification. In some examples, the perception component 622 can provide processed sensor data that indicates a presence of an entity that is proximate to the vehicle(s) 202 and/or a classification of the entity as an entity type (e.g., car, pedestrian, cyclist, building, tree, road surface, curb, sidewalk, unknown, etc.). In additional and/or alternative examples, the perception component 622 can provide processed sensor data that indicates one or more characteristics (also referred to as parameters) associated with a detected entity and/or the environment in which the entity is positioned. In some examples, characteristics associated with an entity can include, but are not limited to, an x-position (global position), a y-position (global position), a z-position (global position), an orientation, an entity type (e.g., a classification), a velocity of the entity, an extent of the entity (size), etc. Characteristics associated with the environment can include, but are not limited to, a presence of another entity in the environment, a state of another entity in the environment, a time of day, a day of a week, a season, a weather condition, a geographic position, an indication of darkness/light, etc.

The perception component 622 can include functionality to store perception data generated by the perception component 622. In some instances, the perception component 622 can determine a track corresponding to an object that has been classified as an object type. For purposes of illustration only, the perception component 622, using sensor system(s) 604 can capture one or more images of an environment. The sensor system(s) 604 can capture images of an environment that includes an object, such as a pedestrian. The pedestrian can be at a first position at a time T and at a second position at time T+t (e.g., movement during a span of time t after time T). In other words, the pedestrian can move during this time span from the first position to the second position. Such movement can, for example, be logged as stored perception data associated with the object.

The stored perception data can, in some examples, include fused perception data captured by the vehicle. Fused perception data can include a fusion or other combination of sensor data from sensor system(s) 604, such as image sensors, lidar sensors, radar sensors, time-of-flight sensors, sonar sensors, global positioning system sensors, internal sensors, and/or any combination of these. The stored perception data can additionally or alternatively include classification data including semantic classifications of objects (e.g., pedestrians, vehicles, buildings, road surfaces, etc.) represented in the sensor data. The stored perception data can additionally or alternatively include a track data (collections of historical positions, orientations, sensor features, etc. associated with the object over time) corresponding to motion of objects classified as dynamic objects through the environment. The track data can include multiple tracks of multiple different objects overtime. This track data can be mined to identify images of certain types of objects (e.g., pedestrians, animals, etc.) at times when the object is stationary (e.g., standing still) or moving (e.g., walking, running, etc.). In this example, the computing device determines a track corresponding to a pedestrian.

The prediction component 624 can generate one or more probability maps representing prediction probabilities of possible locations of one or more objects in an environment. For example, the prediction component 624 can generate one or more probability maps for vehicles, pedestrians, animals, and the like within a threshold distance from the vehicle(s) 202. In some instances, the prediction component 624 can measure a track of an object and generate a discretized prediction probability map, a heat map, a probability distribution, a discretized probability distribution, and/or a trajectory for the object based on observed and predicted behavior. In some instances, the one or more probability maps can represent an intent of the one or more objects in the environment.

The planning component 626 can determine a path for the vehicle(s) 202 to follow to traverse through an environment. For example, the planning component 626 can determine various routes and paths and various levels of detail. In some instances, the planning component 626 can determine a route to travel from a first location (e.g., a current location) to a second location (e.g., a target location). For the purpose of this discussion, a route can be a sequence of waypoints for traveling between two locations. As non-limiting examples, waypoints include streets, intersections, global positioning system (GPS) coordinates, etc. Further, the planning component 626 can generate an instruction for guiding the autonomous vehicle along at least a portion of the route from the first location to the second location. In at least one example, the planning component 626 can determine how to guide the autonomous vehicle from a first waypoint in the sequence of waypoints to a second waypoint in the sequence of waypoints. In some examples, the instruction can be a path, or a portion of a path. In some examples, multiple paths can be substantially simultaneously generated (i.e., within technical tolerances) in accordance with a receding horizon technique. A single path of the multiple paths in a receding data horizon having the highest confidence level may be selected to operate the vehicle.

In other examples, the planning component 626 can alternatively, or additionally, use data from the perception component 622 to determine a path for the vehicle(s) 202 to follow to traverse through an environment. For example, the planning component 626 can receive data from the perception component 622 regarding objects associated with an environment. Using this data, the planning component 626 can determine a route to travel from a first location (e.g., a current location) to a second location (e.g., a target location) to avoid objects in an environment. In at least some examples, such a planning component 626 may determine there is no such collision free path and, in turn, provide a path which brings vehicle(s) 202 to a safe stop avoiding all collisions and/or otherwise mitigating damage.

In at least one example, the computing device(s) 602 can include one or more system controller(s) 628, which can be configured to control steering, propulsion, braking, safety, emitters, communication, and other systems of the vehicle(s) 202. These system controller(s) 628 can communicate with and/or control corresponding systems of the drive system(s) 612 and/or other components of the vehicle(s) 202, which may be configured to operate in accordance with a path provided from the planning component 626.

The vehicle(s) 202 can connect to computing device(s) 630 via network(s) 614 and can include one or more processor(s) 632 and memory 634 communicatively coupled with the one or more processor(s) 632. In at least one instance, the one or more processor(s) 632 can be similar to the processor(s) 616 and the memory 634 can be similar to the memory 618. In the illustrated example, the memory 634 of the computing device(s) 630 stores a scenario editor component 108, a simulation component 112, a collision checker 116, an analysis component 120, a vehicle performance component 122, a miscalibration factor component 124 and a validation component 130. Though depicted as residing in the memory 634 for illustrative purposes, it is contemplated that the scenario editor component 108, the simulation component 112, the collision checker 116, the analysis component 120, the vehicle performance component 122, the miscalibration factor component 124 and the validation component 130 can additionally, or alternatively, be accessible to the computing device(s) 630 (e.g., stored in a different component of computing device(s) 630 and/or be accessible to the computing device(s) 630 (e.g., stored remotely). The scenario editor component 108, the simulation component 112, a collision checker 116, an analysis component 120, a vehicle performance component 122 and a miscalibration factor component 124 can be substantially similar to the scenario editor component 108, the simulation component 112, the collision checker 116, the analysis component 120, the vehicle performance component 122, the miscalibration factor component 124 and the validation component 130 of FIG. 1.

The processor(s) 616 of the computing device(s) 602 and the processor(s) 632 of the computing device(s) 630 can be any suitable processor capable of executing instructions to process data and perform operations as described herein. By way of example and not limitation, the processor(s) 616 and 632 can comprise one or more Central Processing Units (CPUs), Graphics Processing Units (GPUs), or any other device or portion of a device that processes electronic data to transform that electronic data into other electronic data that can be stored in registers and/or memory. In some examples, integrated circuits (e.g., ASICs, etc.), gate arrays (e.g., FPGAs, etc.), and other hardware devices can also be considered processors in so far as they are configured to implement encoded instructions.

The memory 618 computing device(s) 602 and the memory 634 of the computing device(s) 630 are examples of non-transitory computer-readable media. The memory 618 and 634 can store an operating system and one or more software applications, instructions, programs, and/or data to implement the methods described herein and the functions attributed to the various systems. In various implementations, the memory 618 and 634 can be implemented using any suitable memory technology, such as static random access memory (SRAM), synchronous dynamic RAM (SDRAM), nonvolatile/Flash-type memory, or any other type of memory capable of storing information. The architectures, systems, and individual elements described herein can include many other logical, programmatic, and physical components, of which those shown in the accompanying figures are merely examples that are related to the discussion herein.

In some instances, aspects of some or all of the components discussed herein can include any models, algorithms, and/or machine learning algorithms. For example, in some instances, the components in the memory 618 and 634 can be implemented as a neural network.

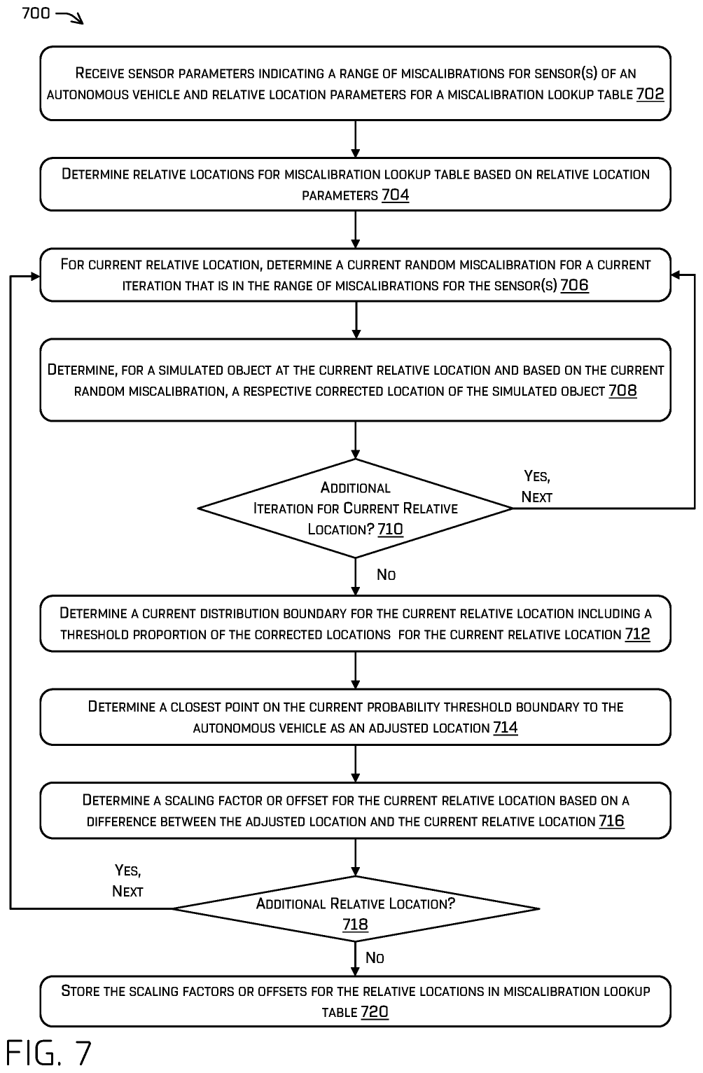

FIG. 7 depicts an example process 700 for determining a miscalibration lookup table that may be used in safety testing an autonomous vehicle controller. More particularly, the miscalibration lookup table may be used by a collision checker 116 to determine whether adverse events such as collisions would have occurred during the simulation if the one or more objects in the scenario were closer than determined by the perception and prediction systems due to a miscalibration of the sensors. Some or all of the process 700 can be performed by one or more components in FIGS. 1-6, as described herein. For example, some or all of the process 700 can be performed by the computing device(s) 630, and/or computing device(s) 602.

At 702, the process 700 can include receiving sensor parameters indicating a range of miscalibrations for sensor(s) of an autonomous vehicle and relative location parameters for generating a miscalibration lookup table. At 704, the process 700 can include determining relative locations for the miscalibration lookup table based on relative location parameters.

At 706, the process 700 can include determining, for a current relative location, a current random miscalibration for a current iteration that is in the range of miscalibrations for the sensor(s). At 708, the process 700 can include determining, for a simulated object at the current relative location and based on the current random miscalibration, a respective corrected location of the simulated object.

At 710, the process 700 can include determining whether additional iteration(s) for additional random miscalibrations remain for the current relative location. For example, the process 700 may perform a number of iterations for each current relative location. The number of iterations may be static or algorithmically determined. If additional iterations remain, the process may return to 706 for the next random miscalibration. Otherwise, the process may continue to 712.

At 712, the process 700 can include determining a current probability threshold boundary for the current relative location including a threshold proportion of the corrected locations for the current relative location. At 714, the process 700 can include determining a closest point on the current distribution boundary to the autonomous vehicle as an adjusted location. Additionally or alternatively, the process 700 may determine the adjusted location by shifting the relative location by the distance from the furthest point within the probability threshold boundary from the relative location. Then, at 716, the process 700 can include determining a scaling factor or offset for the current relative location based on a difference between the adjusted location and the current relative location.

At 718, the process 700 can include determining whether additional relative locations remain (e.g., for the miscalibration lookup table). If additional relative locations remain, the process may return to 706 for the next relative location. Otherwise, the process may continue to 720.

At 720, the process 700 can include storing the scaling factors or offsets for the relative locations in the miscalibration lookup table.

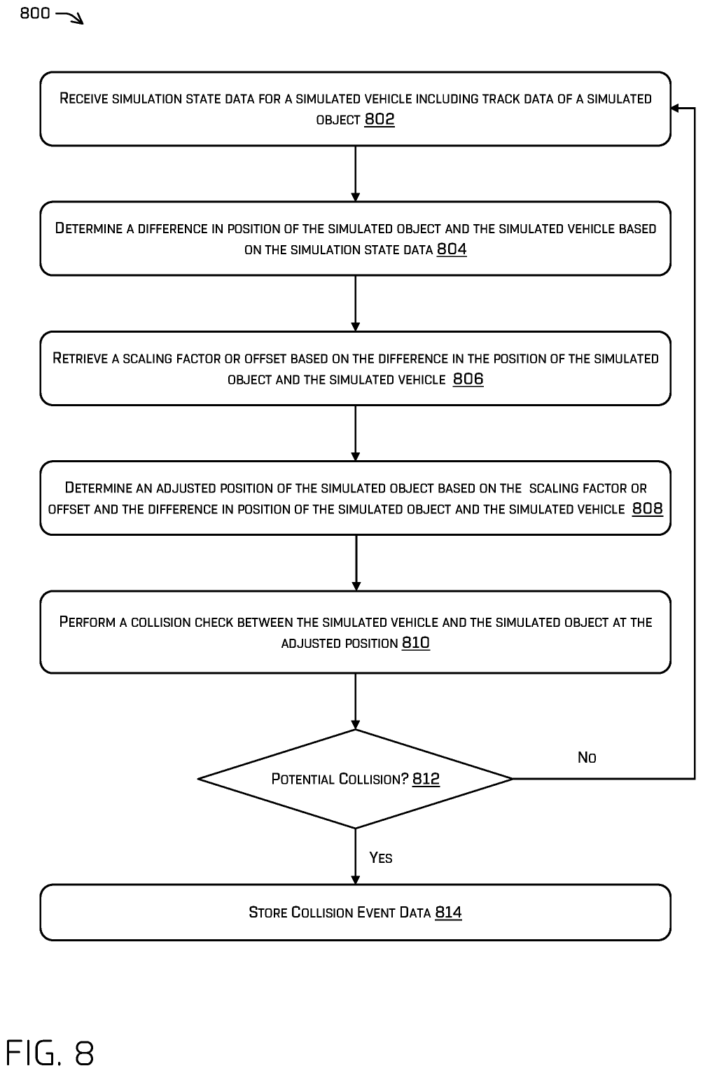

FIG. 8 depicts a flow diagram of an example process for determining whether adverse events may occur due to miscalibration of one or more sensors of a simulated autonomous vehicle. Some or all of the process 800 can be performed by one or more components in FIGS. 1-6, as described herein. For example, some or all of the process 800 can be performed by the computing device(s) 630, and/or computing device(s) 602.

At 802, the process 800 can include receiving simulation state data for a simulated vehicle including track data of a simulated object.

At 804, the process 800 can include determining a difference in position of the simulated object and the simulated vehicle based on the simulation state data. At 806, the process 800 can include retrieving a scaling factor or offset based on the difference in the position of the simulated object and the simulated vehicle. At 808, the process 800 can include determining an adjusted position of the simulated object based on the scaling factor or offset and the difference in position of the simulated object and the simulated vehicle. At 810, the process 800 can include performing a collision check between the simulated vehicle and the simulated object at the adjusted position.

At 812, the process 800 can include determining whether the collision check resulted in a potential collision. If so, the process may continue to 814. Otherwise, the process may return to 802.

At 814, the process 800 may include storing collision event data for the potential collision. Depending on the example, the process may then return to 802 for additional simulation state data or the process 800 may terminate, optionally terminating the simulation producing the simulation state data as well).

### Example Clauses

A. A system comprising: one or more processors; and one or more non-transitory computer-readable media storing computer-executable instructions that, when executed, cause the system to perform operations comprising: executing a simulation representing a driving scenario of a simulated vehicle controlled by an autonomous vehicle controller including: determining a relative location of a simulated object within the simulation with respect to a location of the simulated vehicle; determining, based on the relative location of the simulated object, an adjusted location of the simulated object within the simulation at least in part by shifting the relative location of the simulated object to the adjusted location to correct for a simulated miscalibration of a sensor of the simulated vehicle, wherein the adjusted location is based at least in part on a distribution of a plurality of corrected locations corresponding to a plurality of respective miscalibrations of a sensor of the simulated vehicle within a range of miscalibrations for the sensor and wherein a corrected location of the plurality of corrected locations is determined by shifting a location relative to the sensor associated with the relative location to the corrected location to correct for the respective miscalibration of the sensor; performing a collision check between the simulated vehicle and the simulated object at the adjusted location; and determining, based at least in part an outcome of the collision check, a safety metric associated with the autonomous vehicle controller.

B. The system of clause A, wherein the safety metric indicates that the autonomous vehicle controller operates safely for a threshold portion of miscalibrations within the range of miscalibrations for the sensor, the operations further comprising: configuring an autonomous vehicle to use the autonomous vehicle controller, based at least in part on the safety metric.

C. The system of clause A, wherein the adjusted location is determined at least in part by retrieving an offset or a scaling factor from a miscalibration lookup table based on the relative location of the simulated object, the offset or the scaling factor determined based on a boundary location of the distribution, the boundary encompassing a threshold portion of corrected locations for miscalibrations within the range of miscalibrations for the sensor.

D. The system of clause C, wherein retrieving the one or more the offset or the scaling factor comprises retrieving the scaling factor, and wherein the adjusted location is further determined at least in part by applying the scaling factor to a distance between the relative location of the simulated object and a location of the simulated vehicle.

E. The system of clause C, wherein the boundary location comprises a closest point to the simulated vehicle on the boundary of the distribution.

F. One or more non-transitory computer-readable media storing instructions executable by one or more processors, wherein the instructions, when executed, cause the one or more processors to perform operations comprising: executing a simulation representing a driving scenario of a simulated vehicle controlled by an autonomous vehicle controller, wherein executing the simulation includes: determining a relative location of a simulated object within the simulation with respect to a location of the simulated vehicle; determining, based on the relative location of the simulated object, an adjusted location of the simulated object within the simulation; and performing a collision check between the simulated vehicle and the simulated object at the adjusted location; and determining, based at least in part an outcome of the collision check, a safety metric associated with the autonomous vehicle controller.

G. The one or more non-transitory computer-readable media of clause F, wherein the safety metric indicates that the autonomous vehicle controller operates safely for a threshold portion of miscalibrations within a range of miscalibrations for a sensor of the simulated vehicle, the operations further comprise: configuring an autonomous vehicle to use the autonomous vehicle controller, based at least in part on the safety metric.

H. The one or more non-transitory computer-readable media of clause F, wherein the determining of the adjusted location is based at least in part on shifting the relative location of the simulated object to the adjusted location based at least in part on a distribution of a plurality of corrected locations corresponding to a plurality of respective miscalibrations of a sensor of the simulated vehicle within a range of miscalibrations for the sensor.

I. The one or more non-transitory computer-readable media of clause H, wherein the adjusted location is determined at least in part by retrieving one or more of an offset or scaling factor from a miscalibration lookup table based on the relative location of the simulated object.

J. The one or more non-transitory computer-readable media of clause I, wherein retrieving the one or more the offset or the scaling factor comprises retrieving the scaling factor, and wherein the adjusted location is further determined at least in part by applying the scaling factor to a distance between the relative location of the simulated object and a location of the simulated vehicle.

K. The one or more non-transitory computer-readable media of clause H, wherein a corrected location of the plurality of corrected locations is determined by shifting a location relative to the sensor associated with the relative location to the corrected location to correct for the respective miscalibration of the sensor.

L. The one or more non-transitory computer-readable media of clause H, wherein: the adjusted location is further determined at least in part by applying a scaling factor to a distance between the relative location of the simulated object and a location of the simulated vehicle; the scaling factor is determined based on a boundary location of the distribution; the boundary encompasses a threshold portion of corrected locations for respective miscalibrations within the range of miscalibrations for the sensor; and the boundary location is a closest point to the simulated vehicle on the boundary of the distribution.

M. A method comprising: executing a simulation representing a driving scenario of a simulated vehicle controlled by an autonomous vehicle controller, wherein executing the simulation includes: determining a relative location of a simulated object within the simulation with respect to a location of the simulated vehicle; determining, based on the relative location of the simulated object, an adjusted location of the simulated object within the simulation; and performing a collision check between the simulated vehicle and the simulated object at the adjusted location; and determining, based at least in part an outcome of the collision check, a safety metric associated with the autonomous vehicle controller.

N. The method of clause M, wherein the safety metric indicates that the autonomous vehicle controller operates safely for a threshold portion of miscalibrations within a range of miscalibrations for a sensor of the simulated vehicle, the method further comprising: configuring an autonomous vehicle to use the autonomous vehicle controller, based at least in part on the safety metric.

O. The method of clause M, wherein the determining of the adjusted location is based at least in part on shifting the relative location of the simulated object to the adjusted location based at least in part on a distribution of a plurality of corrected locations corresponding to a plurality of respective miscalibrations of a sensor of the simulated vehicle within a range of miscalibrations for the sensor.

P. The method of clause O, wherein the adjusted location is determined at least in part by retrieving one or more of an offset or scaling factor from a miscalibration lookup table based on the relative location of the simulated object.

Q. The method of clause P, wherein retrieving the one or more the offset or the scaling factor comprises retrieving the scaling factor, and wherein the adjusted location is further determined at least in part by applying the scaling factor to a distance between the relative location of the simulated object and a location of the simulated vehicle.

R. The method of clause O, wherein a corrected location of the plurality of corrected locations is determined by shifting a location relative to the sensor associated with the relative location to the corrected location to correct for the respective miscalibration of the sensor.

S. The method of clause O, wherein: the adjusted location is further determined at least in part by applying a scaling factor to a distance between the relative location of the simulated object and a location of the simulated vehicle; the scaling factor is determined based on a boundary location of the distribution; the boundary encompasses a threshold portion of corrected locations for respective miscalibrations within the range of miscalibrations for the sensor; and the boundary location is a closest point to the simulated vehicle on the boundary of the distribution.

T. The method of clause M, wherein the autonomous vehicle controller performs operations of one or more of a perception system, a prediction system, or a planner system.

While the example clauses described above are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
one or more processors; and
one or more non-transitory computer-readable media storing computer-executable instructions that, when executed, cause the system to perform operations comprising:
executing a simulation representing a driving scenario of a simulated vehicle controlled by an autonomous vehicle controller including:
determining a relative location of a simulated object within the simulation with respect to a location of the simulated vehicle;
determining, based on the relative location of the simulated object, an adjusted location of the simulated object within the simulation at least in part by shifting the relative location of the simulated object to the adjusted location to correct for a simulated miscalibration of a sensor of the simulated vehicle, wherein the adjusted location is based at least in part on a distribution of a plurality of corrected locations corresponding to a plurality of respective miscalibrations of a sensor of the simulated vehicle within a range of miscalibrations for the sensor and wherein a corrected location of the plurality of corrected locations is determined by shifting a location relative to the sensor associated with the relative location to the corrected location to correct for the respective miscalibration of the sensor;
performing a collision check between the simulated vehicle and the simulated object at the adjusted location; and
determining, based at least in part an outcome of the collision check, a safety metric associated with the autonomous vehicle controller.

2. The system of claim 1, wherein the safety metric indicates that the autonomous vehicle controller operates safely for a threshold portion of miscalibrations within the range of miscalibrations for the sensor, the operations further comprising:
configuring an autonomous vehicle to use the autonomous vehicle controller, based at least in part on the safety metric.

3. The system of claim 1, wherein the adjusted location is determined at least in part by retrieving an offset or a scaling factor from a miscalibration lookup table based on the relative location of the simulated object, the offset or the scaling factor determined based on a boundary location of the distribution, the boundary encompassing a threshold portion of corrected locations for miscalibrations within the range of miscalibrations for the sensor.

4. The system of claim 3, wherein retrieving the one or more the offset or the scaling factor comprises retrieving the scaling factor, and wherein the adjusted location is further determined at least in part by applying the scaling factor to a distance between the relative location of the simulated object and a location of the simulated vehicle.

5. The system of claim 3, wherein the boundary location comprises a closest point to the simulated vehicle on the boundary of the distribution.

6. One or more non-transitory computer-readable media storing instructions executable by one or more processors, wherein the instructions, when executed, cause the one or more processors to perform operations comprising:
executing a simulation representing a driving scenario of a simulated vehicle controlled by an autonomous vehicle controller, wherein executing the simulation includes:
determining a relative location of a simulated object within the simulation with respect to a location of the simulated vehicle;
determining, based on the relative location of the simulated object, an adjusted location of the simulated object within the simulation; and
performing a collision check between the simulated vehicle and the simulated object at the adjusted location; and
determining, based at least in part an outcome of the collision check, a safety metric associated with the autonomous vehicle controller.

7. The one or more non-transitory computer-readable media of claim 6, wherein the safety metric indicates that the autonomous vehicle controller operates safely for a threshold portion of miscalibrations within a range of miscalibrations for a sensor of the simulated vehicle, the operations further comprise:
configuring an autonomous vehicle to use the autonomous vehicle controller, based at least in part on the safety metric.

8. The one or more non-transitory computer-readable media of claim 6, wherein the determining of the adjusted location is based at least in part on shifting the relative location of the simulated object to the adjusted location based at least in part on a distribution of a plurality of corrected locations corresponding to a plurality of respective miscalibrations of a sensor of the simulated vehicle within a range of miscalibrations for the sensor.

9. The one or more non-transitory computer-readable media of claim 8, wherein the adjusted location is determined at least in part by retrieving one or more of an offset or scaling factor from a miscalibration lookup table based on the relative location of the simulated object.

10. The one or more non-transitory computer-readable media of claim 9, wherein retrieving the one or more the offset or the scaling factor comprises retrieving the scaling factor, and wherein the adjusted location is further determined at least in part by applying the scaling factor to a distance between the relative location of the simulated object and a location of the simulated vehicle.

11. The one or more non-transitory computer-readable media of claim 8, wherein a corrected location of the plurality of corrected locations is determined by shifting a location relative to the sensor associated with the relative location to the corrected location to correct for the respective miscalibration of the sensor.

12. The one or more non-transitory computer-readable media of claim 8, wherein:
the adjusted location is further determined at least in part by applying a scaling factor to a distance between the relative location of the simulated object and a location of the simulated vehicle;
the scaling factor is determined based on a boundary location of the distribution;
the boundary encompasses a threshold portion of corrected locations for respective miscalibrations within the range of miscalibrations for the sensor; and
the boundary location is a closest point to the simulated vehicle on the boundary of the distribution.

13. A method comprising:
executing a simulation representing a driving scenario of a simulated vehicle controlled by an autonomous vehicle controller, wherein executing the simulation includes:
determining a relative location of a simulated object within the simulation with respect to a location of the simulated vehicle;
determining, based on the relative location of the simulated object, an adjusted location of the simulated object within the simulation; and
performing a collision check between the simulated vehicle and the simulated object at the adjusted location; and
determining, based at least in part an outcome of the collision check, a safety metric associated with the autonomous vehicle controller.

14. The method of claim 13, wherein the safety metric indicates that the autonomous vehicle controller operates safely for a threshold portion of miscalibrations within a range of miscalibrations for a sensor of the simulated vehicle, the method further comprising:
configuring an autonomous vehicle to use the autonomous vehicle controller, based at least in part on the safety metric.

15. The method of claim 13, wherein the determining of the adjusted location is based at least in part on shifting the relative location of the simulated object to the adjusted location based at least in part on a distribution of a plurality of corrected locations corresponding to a plurality of respective miscalibrations of a sensor of the simulated vehicle within a range of miscalibrations for the sensor.

16. The method of claim 15, wherein the adjusted location is determined at least in part by retrieving one or more of an offset or scaling factor from a miscalibration lookup table based on the relative location of the simulated object.

17. The method of claim 16, wherein retrieving the one or more the offset or the scaling factor comprises retrieving the scaling factor, and wherein the adjusted location is further determined at least in part by applying the scaling factor to a distance between the relative location of the simulated object and a location of the simulated vehicle.

18. The method of claim 15, wherein a corrected location of the plurality of corrected locations is determined by shifting a location relative to the sensor associated with the relative location to the corrected location to correct for the respective miscalibration of the sensor.

19. The method of claim 15, wherein:
the adjusted location is further determined at least in part by applying a scaling factor to a distance between the relative location of the simulated object and a location of the simulated vehicle;
the scaling factor is determined based on a boundary location of the distribution;
the boundary encompasses a threshold portion of corrected locations for respective miscalibrations within the range of miscalibrations for the sensor; and
the boundary location is a closest point to the simulated vehicle on the boundary of the distribution.

20. The method of claim 13, wherein the autonomous vehicle controller performs operations of one or more of a perception system, a prediction system, or a planner system.
